(19) United States
(12) Patent Application Publication
(10) Pub. No.: US 2004/0243679 A1
(43) Pub. Date: Dec. 2, 2004

(54) Email management

(76) Inventor: Joshua Rogers Tyler, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/448,032

(22) Filed: May 28, 2003

(51) Int. Cl. G06F 15/16

(52) U.S. Cl. 709/206

(57) ABSTRACT

Method and apparatus for managing email messages for a user. A responsiveness metric that describes a level of responsiveness may be determined as a function of a plurality of response time periods, each response time period being an amount of time elapsed between sending an email message and receiving a reply to the email message. Information indicative of the responsiveness metric is displayed for the user.

### FIELD OF THE INVENTION

The present disclosure generally relates to email management.

### BACKGROUND

Email communication has become a very popular and useful form of business and personal communication. However, at times email can be cumbersome and difficult to manage due to the large volume of messages. Additionally, many users have multiple email accounts, which further complicate matters.

Email has evolved into a tool used for more than just communication. Feature rich programs allow a user to manage a calendar, address book, or topical conservation archive. Advanced email management systems prioritize email for users. Other email management systems route emails with a timer queue.

As personal and business relations increasingly rely on email, responsiveness to email messages may affect the quality of the relationships. The timeliness of replies to incoming email often depends on the identities of the senders and subject matters of the messages. For mail sent by a user, the user may have an expectation of as to how quickly a particular recipient will reply to messages.

Email users often rely on past experiences in deciding how quickly to reply to received messages and in determining how quickly responses might be expected for sent messages. Users generally want to create a positive impression by quickly replying to email messages, although at times may prefer to convey other impressions, such as inaccessibility or superior status, by deliberately responding slowly. Furthermore, the time taken for a recipient to reply to an email may be affected by many other factors, such as his relative current workload, size of his email queue, or absence from the workplace. However, the email sender generally is oblivious to these factors, and sees only the explicit temporal responsiveness of the recipient. Email correspondents may also tend to reciprocate each other's behavior in terms of response time to email messages, and have a desire to maintain this reciprocity.

### SUMMARY

Various methods and apparatus are disclosed for management of email messages. A responsiveness metric that describes a level of responsiveness may be determined as a function of a plurality of response time periods, each response time period being an amount of time elapsed between sending an email message and receiving a reply to the email message. Information indicative of the responsiveness metric is displayed for the user.

### BRIEF DESCRIPTION OF THE DRAWINGS

FIG. 1 is a block diagram that illustrates an example arrangement of email clients and email servers;

FIG. 2 is a flowchart of an example process for processing user input;

FIG. 3 shows an example window of average response times and percentage responsiveness values;

FIG. 4A shows an example window of local responsiveness data of a subset of correspondents;

FIG. 4B shows an example window for another subset of correspondents where the response differences transition from positive values to negative values;

FIG. 4C shows an example window in which the responsiveness data for the correspondents are presented in order of the increasing amounts of time that have passed since the user last sent a message to the correspondents;

FIG. 5 shows a window of example responsiveness data including global responsiveness data for some of the correspondents;

FIG. 6 is a flowchart of an example process that is performed in receiving an email message;

FIG. 7 is a flowchart of an example process for sending an email message; and

FIG. 8 is a flowchart of an example process for automatically notifying a user of greater than expected delays in receiving replies or replying to received messages.

### DETAILED DESCRIPTION

The disclosure describes various methods and apparatus for providing assistance to a user in managing email. For example, email communication data is collected and analyzed to indicate a level of responsiveness for each email correspondent. With this information, the user may decide how quickly to respond to an incoming message from a correspondent or determine how quickly a correspondent might reply to a message from the user.

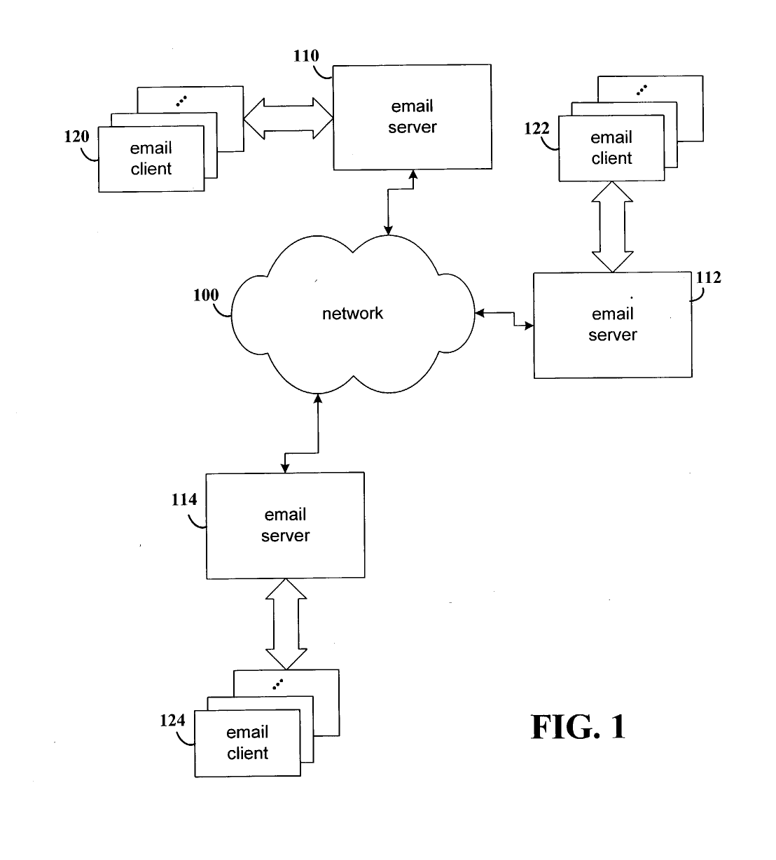

FIG. 1 is a block diagram that illustrates an example arrangement of email clients and email servers. The components include network 100, email servers 110, 112, and 114, and groups of email clients 120, 122, and 124. The email servers generally handle the routing of email messages between email clients via the network. For example, email clients 120 send and receive email messages via email server 110, and email server 110 communicates with email servers 112 and 114 in sending and receiving the email messages on behalf of the email clients 120. The email servers and email clients may be commercially available or proprietary components that are adapted to provide the described email management function, and network 100 may range from a local area network to the Internet. Depending on implementation requirements, the email management functions may be implemented on the email clients or on the email servers, or the functions may be distributed between the email clients and email servers.

Various data and indicators that may be helpful in prioritizing responses to email messages and determining when a reply might be expected from a correspondent may be presented to the user. In one embodiment, an average response time and a percentage responsiveness of a correspondent are available to the user. In an example embodiment, the average response time is the average of the time periods it takes for a correspondent to reply to messages from the user, where each time period is the difference between the time at which the message was sent and the time at which a reply to the message was received. For example, the average response time presented to a user of one of email clients 120 may refer to the average of the time it takes a correspondent at one of email clients 124 to reply to messages from the user. The percentage responsiveness of a correspondent is the percent of the number of message sent by a user to the correspondent to which the correspondent has sent a reply message. In the example embodiment, an unsolicited message from a correspondent is not counted as a reply in computing either the average response time or the percentage responsiveness. It will be appreciated that in other embodiments, metrics other than an average, for example, a median, may be used to characterize responsiveness.

In another embodiment, the user may be provided with information that indicates the difference in responsiveness between the user and a correspondent. For example, if a user at one of email clients 120 replies to messages from a correspondent at one of email clients 122 faster than the correspondent replies to messages from the user, then the user may be apprised of this information. With this information, the user may, depending on the relationship, relative positions of the user and correspondent and other circumstances, give messages from the correspondent a lower priority relative to messages from other correspondents for purposes of responding to a collection of email messages.

Information may also be provided to a user to indicate when a correspondent fails to respond to a message within some expected period of time. For example, if a correspondent at one of email clients 124 on average replies to messages from the user of one of email clients 120 within 24 hours, then the user may find it helpful to know if the correspondent has not replied to or sent a message in 3 days. In this situation, the user may want to send a follow-up message.

In another embodiment, the user may be apprised as to the user's current level of responsiveness to correspondents relative to the user's average responsiveness to messages from those correspondents. For example, a visual cue may be provided to indicate when the user's current level of responsiveness to messages from a correspondent is slower than the user's average responsiveness to messages from that correspondent. Similarly, a visual cue may be provided to indicate when the user's current level of responsiveness to messages from a correspondent is faster than the user's average responsiveness to messages from that correspondent.

In further embodiments, the data and visual cues presented to a user may further relate each correspondent's level of responsiveness to messages received by that correspondent from other correspondents. Thus, not only does a user have a view of responsiveness data that is relative to the user's interactions with a correspondent, but also a view of the correspondent's level of responsiveness to other correspondents. For example, an indication may be provided to a user at one of email clients 120 as to how responsive a correspondent at one of email clients 124 is to messages the correspondent receives from other users of email clients 120, 122, and 124. For ease of discussion, local responsiveness data refers to responsiveness data that is relative to the user's interactions with a correspondent, and global responsiveness data refers to a correspondent's level of responsiveness to all those with whom the correspondent exchanges email messages.

Global responsiveness data may be selectively communicated from the component that gathers the data (e.g., an email client or server) to the email client that communicates the data to a user. For example, if one of email clients 124 is gathering data relative to a user's responsiveness to incoming messages, that responsiveness data may be communicated to a user of one of email clients 120. A user may be provided with controls for turning on and turning off the gathering and reporting of global responsiveness data.

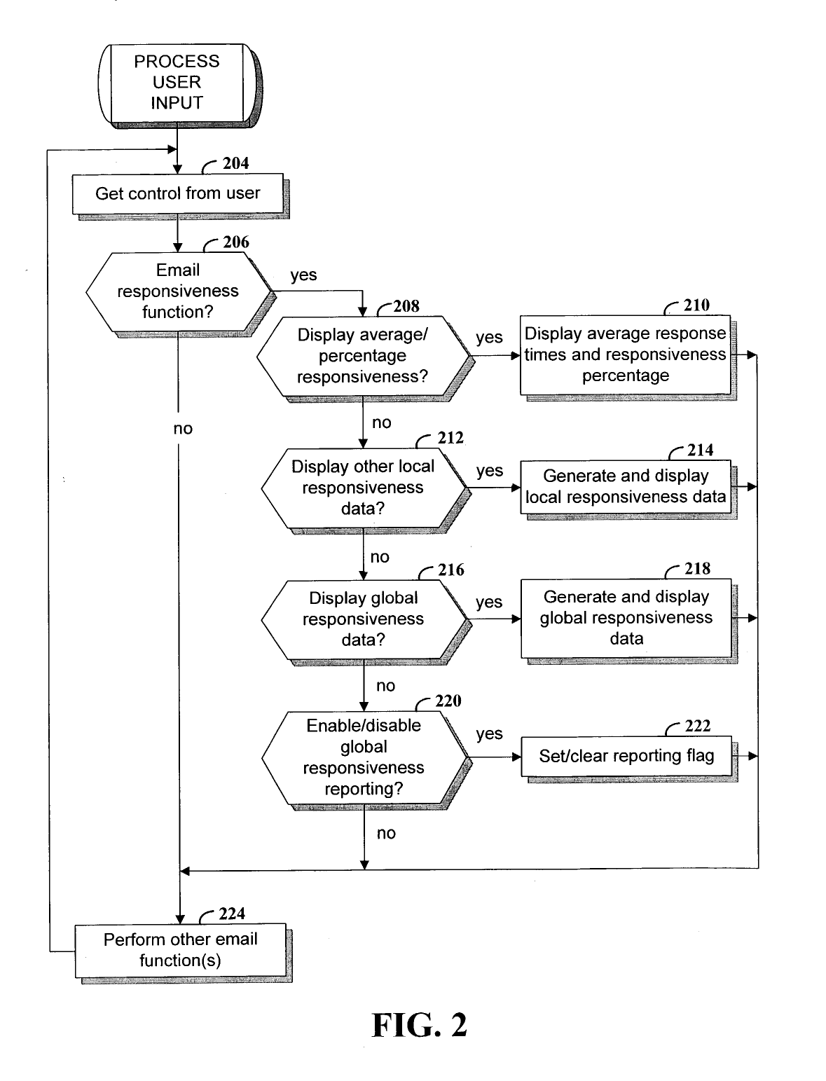

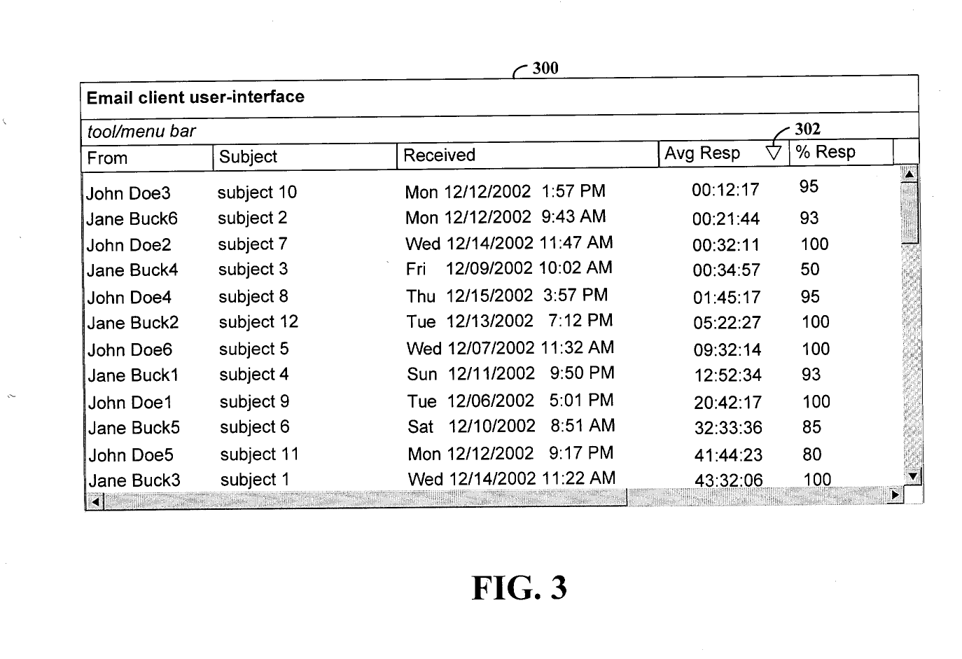

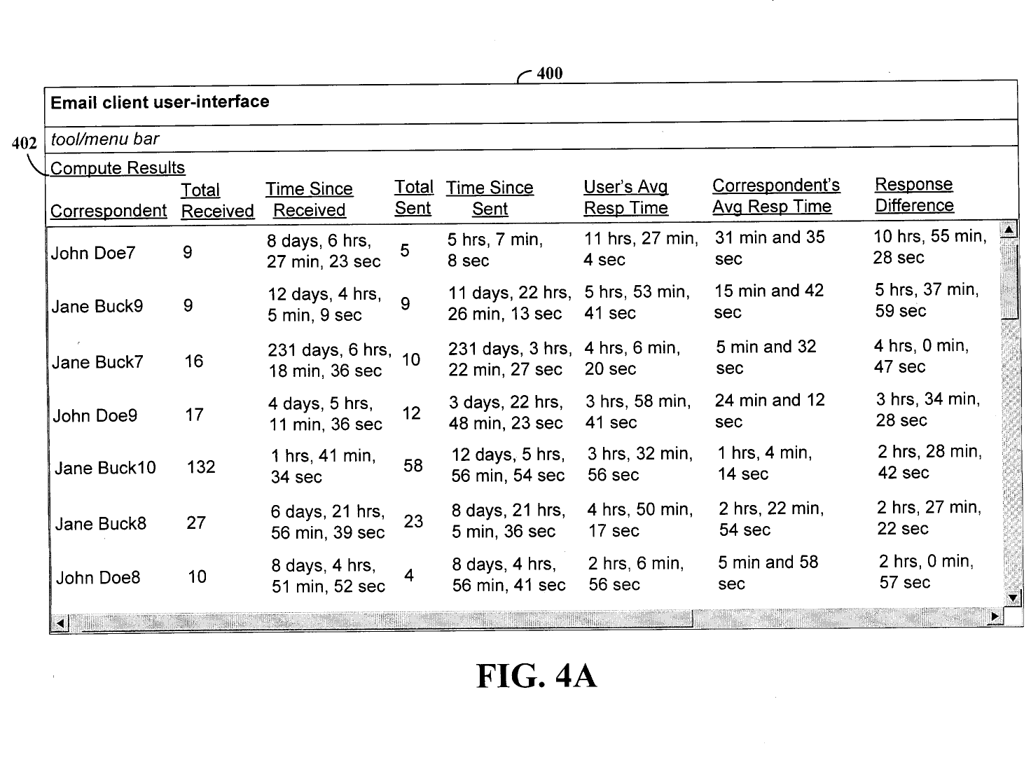

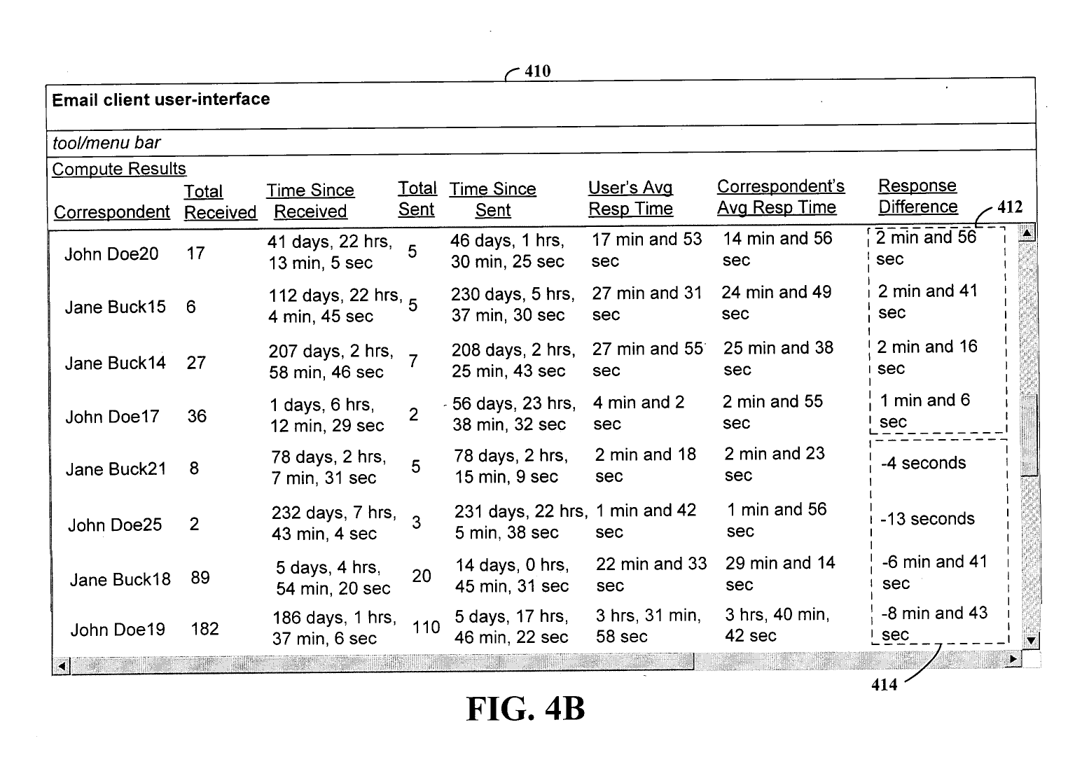

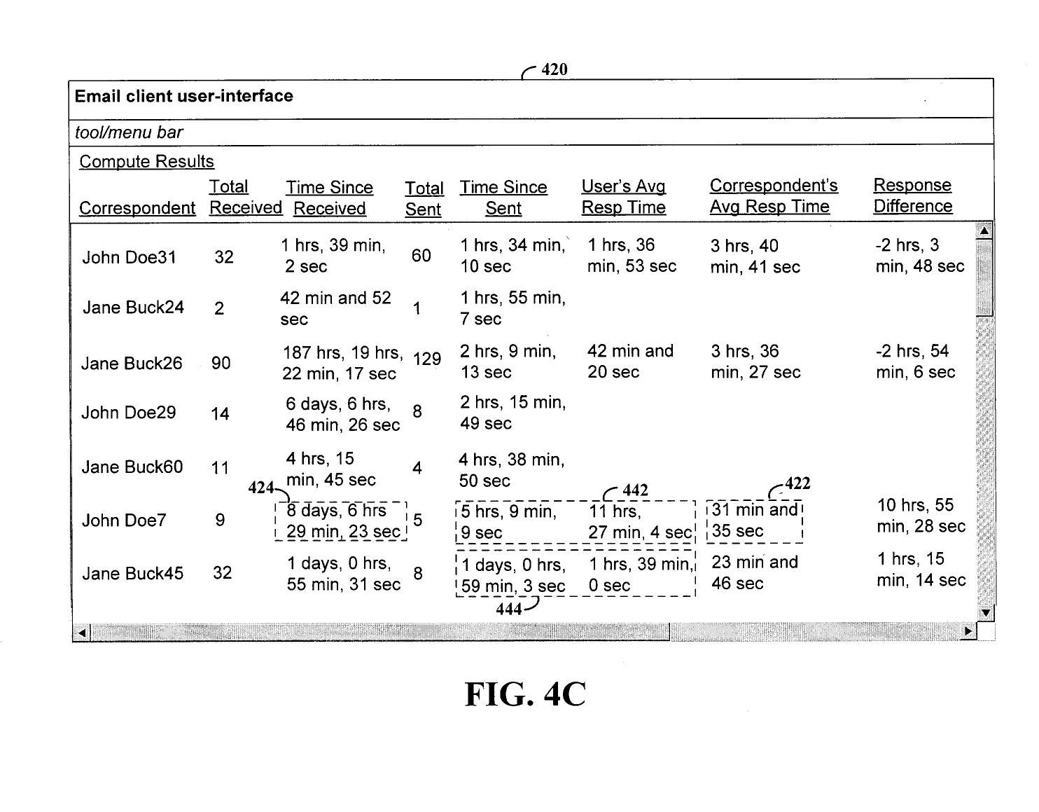

FIG. 2 is a flowchart of an example process for processing user input in accordance with various embodiments. The process is described within the context of processing user interface controls as input by a user in operating an email client. Descriptions of example user-interface windows in FIGS. 3, 4A-C, and 5 are presented in conjunction with the description of FIG. 2 in order to illustrate how responsiveness data may be communicated to a user in various example embodiments. A user-interface control (e.g., menu selection, point-and-click, or command) is obtained from the user (block 204), and the action taken by the email client depends on the control (decision block 206). For a function related to presenting responsiveness data, the process proceeds to present various responsiveness data.

In one embodiment, the user may select a control that causes the email client to display in association with received messages (or sent messages) the average response times of the correspondents and the percentage responsiveness of the correspondents (decision block 208). The messages may also be sorted by correspondents' average response times or percentage responsiveness. The email client presents the average response times, responsiveness percentage, and or sorts the messages in response to the user's selection (block 210).

FIG. 3 shows an example window 300 of average response times and percentage responsiveness. The example data summarizes a user's received email messages (or a subset thereof), including correspondent identifiers, subjects, times of receipt, average response times, and percentages of responsiveness. Triangle 302 indicates that the summary information has been sorted from least average response time (fastest to reply) to the greatest average response time (slowest to reply). For example, correspondent John Doe3 who is listed first has the fastest average response time (Avg Resp) of 12 minutes 17 seconds, and Jane Buck3 is listed last in the window with an average response time of 43 hours 32 minutes 6 seconds. The average response time value that is associated with a correspondent is the average of the differences between the times at which the user sent email messages and the times at which the correspondent replied to the messages. In one embodiment, if the correspondent does not reply to a message the message is not factored into the average. In another embodiment, the current time may be used to compute an assumed response time for a message to which the correspondent has not replied. In another embodiment, the sort order may be reversed by alternately clicking on the Avg Resp column heading.

While not shown, it will be appreciated that the summary information may also be sorted by percentage responsiveness (% Resp), either from highest to lowest or from lowest to highest. The percentage responsiveness value that is associated with a correspondent is the percentage of the number messages sent from the user to the correspondent to which the correspondent has generated a reply message.

Returning to FIG. 2, the user may chose a function that involves the display of other local responsiveness data (decision block 212). The other types of local responsiveness data that are generated and displayed (block 214) are illustrated in FIGS. 4A-4C. FIG. 4A shows an example window 400 of local responsiveness data of a subset of correspondents. Window 400 shows for each correspondent the correspondent identifier, total number of messages received from the correspondent (Total Received), amount of time passed since the last message was received from the correspondent (Time Since Received), total number of messages sent to the correspondent (Total Sent), time passed since the last message was sent to the correspondent (Time Since Sent), average amount of time the user takes to respond to the correspondent (User's Avg Resp Time), average amount of time the correspondent takes to respond to the user (Correspondent's Avg Resp Time), and the difference (Response Difference) between the User 's Avg Resp Time and the Correspondent's Avg Resp Time. The correspondents are ordered from the slowest to fastest response difference (Response Difference) in window 400. For example, John Doe7 on average takes 31 minutes 35 seconds to respond to the user's messages, and the user takes on average 11 hours, 27 minutes, 4 seconds to respond to messages from John Doe7. The 10 hour, 55 minute, 28 seconds under Response Difference generally shows how much longer the user takes to respond to John Doe7 than John Doe7 takes to respond to the user and is the difference between the user's average response time (User's Avg Resp Time) and the correspondent's average response time (Correspondent's Avg Resp Time).

The Compute Results title 402 is selectable, for example, via a point-and-click device or similar selection mechanism, for invoking a function that updates the responsiveness data in the window 400. The function computes new values as a function of the current time and the times at which any new messages have been received from the correspondents or sent by the user. In another embodiment, the values may be recomputed automatically at regular intervals. Each of the column headings (Correspondent, Total Received, Time Since Received, Total Sent, Time Since Sent, Avg Sent Resp Time, Avg Rec'd Resp Time, and Res Diff) may also be selectable for presenting the responsiveness data sorted by values under the selected heading and re-computing metrics.

FIG. 4B shows an example window 410 for another subset of correspondents where the response difference values (Response Difference) transition from positive values to negative values. Where the values are positive (block 412), the correspondent is responding faster on average to messages from the user than the user is responding to messages from the correspondent, and where the values are negative (block 414), the correspondent is responding slower on average to messages from the user than the user is responding to messages from the correspondent. The email client may provide visual indicators to the user in order to draw attention to the different values. For example, positive values may be presented in green and negative values in red or visa versa depending on the user's objectives or implementation requirements.

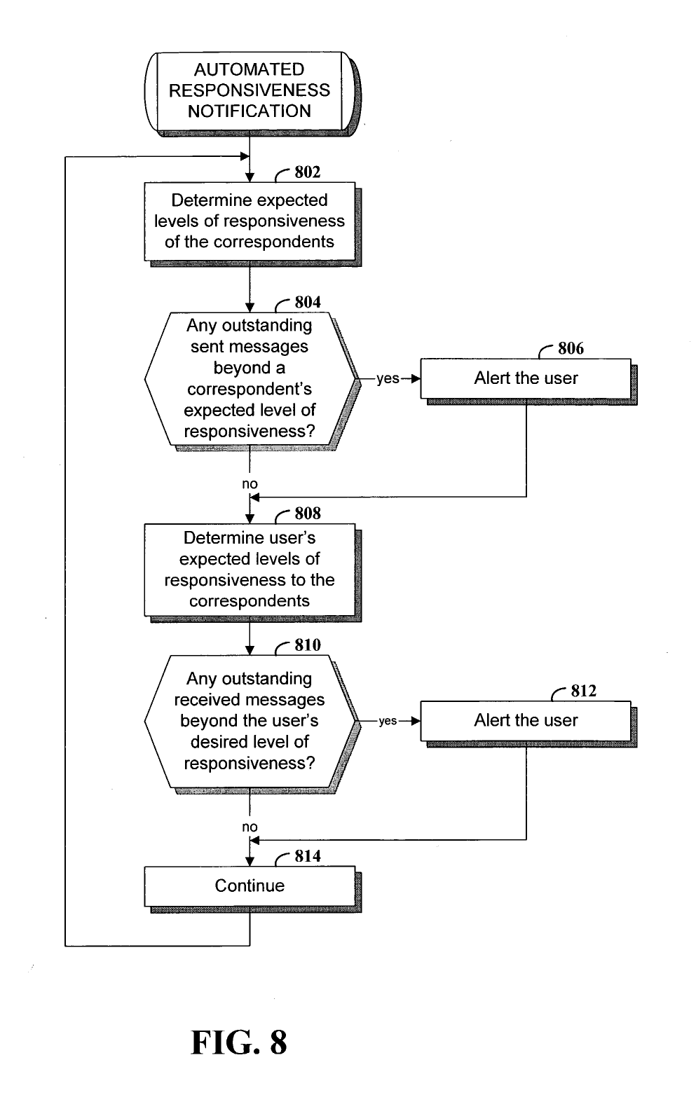

The correspondent responsiveness data of FIGS. 4A and 4B may be alternatively presented in order of the amounts of time that have passed since the user last sent messages to the correspondents (Time Since Sent). For example, FIG. 4C shows an example window 420 in which the responsiveness data for the correspondents are presented in order of the increasing amounts of time that have passed since the user last sent a message to the correspondents. This ordering may be useful in identifying correspondents who have not responded within their average response times, which may indicate that a follow-up message is necessary. For example, John Doe 7 on average replies to an email message in 31 minutes 35 seconds (block 422), but the time that has passed since a message was last received from John Doe7 is over 8 days (block 424) and the last message was sent to John Doe7 about 5 hours ago. This information may be color coded or flashed to call the user's attention to a greater than expected delay in a correspondent's replying to messages. In another embodiment, a reminder may be issued in the form of system-generated email message or a task to indicate that a follow-up message may be desirable (FIG. 8).

In another example embodiment, an indicator may be presented to the user when a correspondent has not replied to a particular email message within the correspondent's average response time plus some additional buffer period of time. For example, the indicator may be provided in a column containing the Time Since Received data in a window of data that displays the user's sent messages (not shown).

The data in window 420 may also be used to show when the user's current level of responsiveness to a correspondent is slower than what the correspondent might see from the user on average. The indication may be communicated by color-coding the data. For example, the color blue may be used to display data where the user's current level of responsiveness to a correspondent is within the user's average time of reply. For example, the responsiveness data displayed for John Doe7 may include blue figures (box 442) for the Time Since Sent and for the User's Avg Resp Time because the time that has passed since the user last sent a message to John Doe7 (5 hrs, 9, min, 9 sec) is less than the average response time of the user (11 hrs, 27 min, 4 sec).

The color red may be used to display data where the user's current level of responsiveness to a correspondent is slower than the user's average time of reply by some selected amount. For example, the responsiveness data displayed for Jane Buck45 may include red figures (box 444) for the Time Since Sent and for the User 's Avg Resp Time because the time that has passed since the user last sent a message to Jane Buck45 (1 day, 0 hrs, 59, min, 3 sec) is much greater than the average response time of the user (1 hrs, 39 min, 0 sec). In another embodiment, a reminder may be issued in the form of system-generated email message or a task to indicate that action to handle the particular email messages (such as replying) on the part of the user may be desirable (FIG. 8).

Returning to FIG. 2, if the user selects a function that involves the display of global responsiveness data (decision block 216), the global responsiveness data is generated and displayed for the user (block 218). Global responsiveness data refers to the responsiveness data of a correspondent relative to others with whom the correspondent communicates via email. Because an email client does not have visibility as to the responsiveness of a correspondent relative to those other than the user, this information may be reported to an email client (or email server depending on the implementation) rather then gathered by the client (or server). Thus, each email client may gather user responsiveness data that indicates a collective level of responsiveness to all the correspondents of the user and report that data to other email clients. This gathering and reporting of user responsiveness data may be selectably enabled or disabled according to the user's preferences.

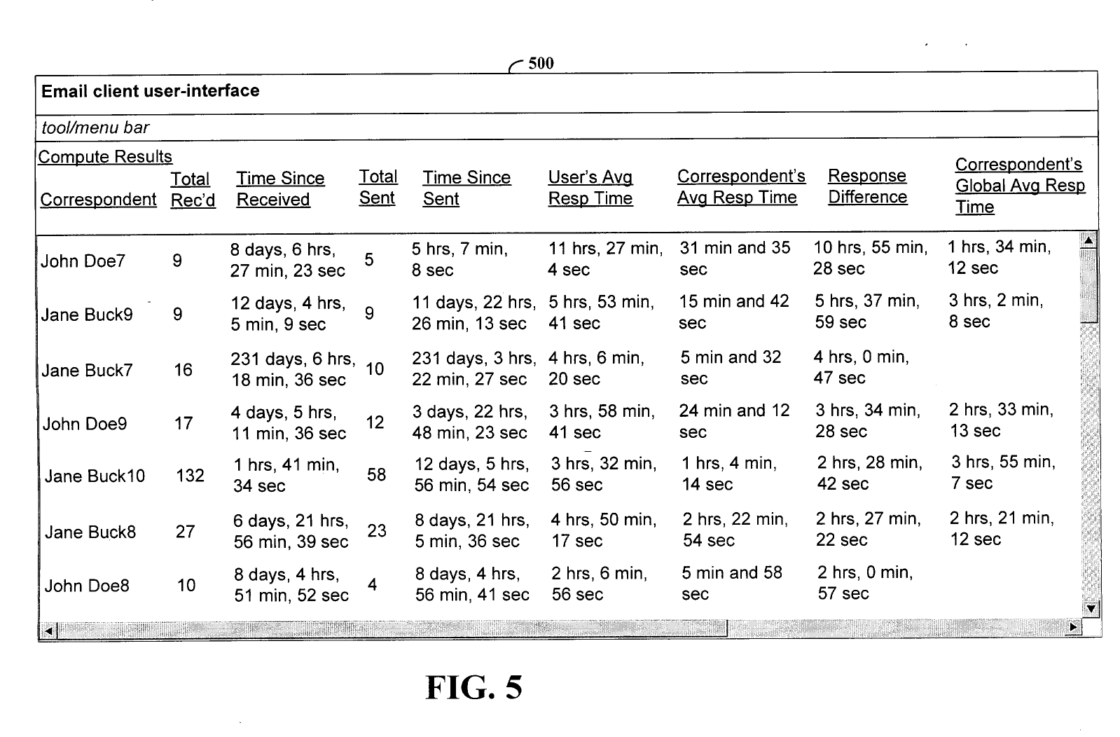

FIG. 5 shows a window 500 of example responsiveness data including global responsiveness data for some of the correspondents. FIG. 5 has the same local responsiveness data as shown in window 400 of FIG. 4A and in addition includes global responsiveness data (Correspondent's Global Avg Resp Time). Each global responsiveness data entry represents the responsiveness of a correspondent to all of those with whom the correspondent communicates. Specifically, each value is the average of the times it takes for the correspondent to reply to all messages.

For example, John Doe7 replies to the user within 31 minutes 35 seconds on average (Correspondents' Avg Resp Time), and he replies to all of the messages he receives in 1 hour, 34 minutes, 12 seconds on average. This informs the user that John Doe7 generally replies to the user faster than he replies to others who send him messages.

In another example embodiment, the user has the option of enabling the collecting and reporting of global responsiveness data. For example, no global responsiveness data is shown for Jane Buck7 and John Doe8 because the collection and reporting of this data has been disabled at their email clients. Likewise, the user may choose a function to enable or disable reporting of the user's global responsiveness data (FIG. 3, decision block 220), and a flag may be set to disable this feature (block 222). After displaying the responsiveness data, or if no responsiveness function was selected, the process continues by performing other email-related processing activities (block 224).

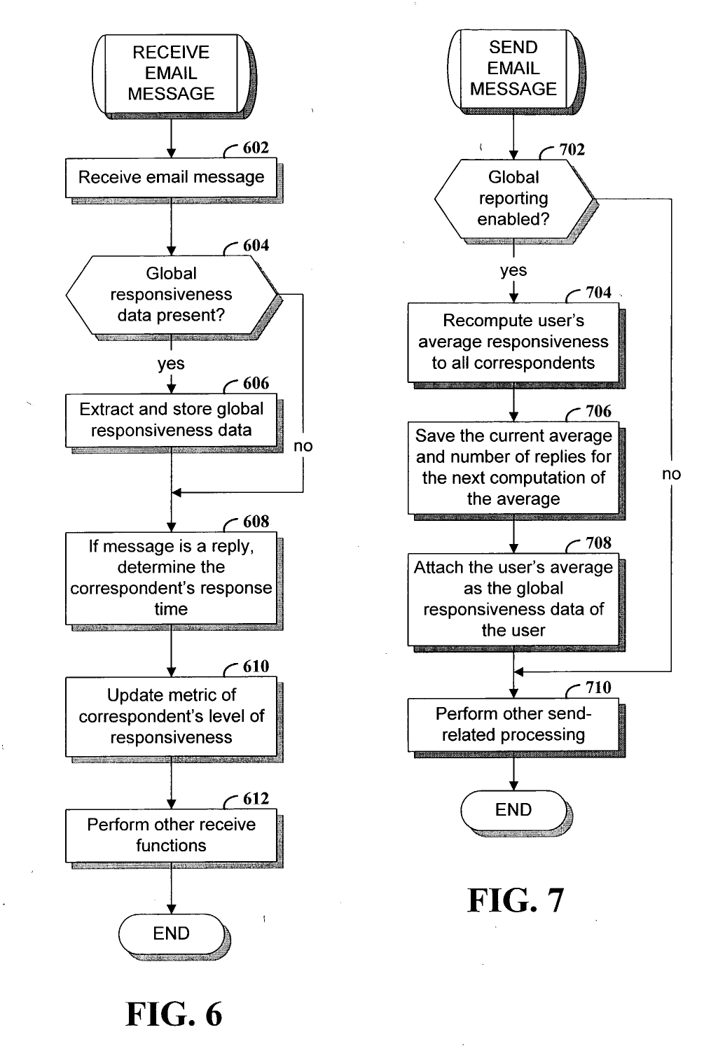

FIG. 6 is a flowchart of an example process that is performed in receiving an email message in accordance with various embodiments. When a message is received (block 602), the process checks whether there is global responsiveness data that accompanies the message. If the global responsiveness data is present (decision block 604), the data may be extracted and stored in association with an identifier of the sender (block 606). This data may be updated when new global responsiveness data is received from the sender. Alternatively, the global responsiveness data may remain with the message, and the most recent message from the sender present in the user's set of received messages may be used to obtain the sender's global responsiveness data.

In another embodiment, the metric that describes a correspondent's level of responsiveness may be updated as each reply is received from the correspondent. If a received message is a reply to a message sent from the user, the correspondent-response time period is determined by the difference between the time of reply and the time of the user's message to the correspondent (block 608). The metric that describes the correspondent's level of responsiveness may then be updated and saved (block 610). For example, a running average or median value of the correspondent-response time periods may be maintained for each correspondent.

The process then performs other implementation-specific functions associated with receiving email messages (block 612), such as signaling the user that a message has arrived.

FIG. 7 is a flowchart of an example process for sending an email message in accordance with various embodiments. In response to the user initiating sending of an email message, the process checks whether the user has enabled the reporting of global responsiveness data (decision block 702). If so, the process updates the user's global responsiveness data by re-computing the average time it takes the user to reply to email messages (block 704). In one embodiment, a running average is determined each time the user replies to an email message. The new current average is saved along with the current total number of replies used in computing the average (block 706). The current average may be attached to the outgoing email message (block 708). The process then performs other implementation-specific functions associated with sending email messages (block 710).

FIG. 8 is a flowchart of an example process for automatically notifying a user of greater than expected delays in receiving replies or replying to received messages. As indicated above in the discussion of FIG. 4C, the user may be automatically notified by way of a system-generated email or task, for example, in the event that a correspondent has not replied to a message within some expected period of time or if the user has failed to reply to a correspondent within some period of time.

A metric that describes each correspondent's expected level of responsiveness is determined (block 802). The metric may be determined as the average of the correspondent-response time periods, as the median of the time periods, as some amount above the average or median, or as a user-selected value, for example. If there are any outstanding messages (no reply received) from the user to a correspondent for which the amount of time passed since the message was sent is greater than the expected level of responsiveness of the correspondent (decision block 804), the user is alerted that some follow-up action may be desirable (block 806). A separate alert (e.g., mail message, task, or pop-up window) may be generated for each correspondent for whom there are such outstanding messages, or a single alert that identifies each such correspondent may be generated.

System-generated alerts may also be generated to call the user's attention to messages received from correspondents to which the user has not replied in some expected period of time. Respective metrics that indicate the user's expected levels of responsiveness to the correspondents are determined (block 808). For example, for each correspondent the metric may be the average of the user-response time periods of replies to that correspondent, the median of the time periods, some amount above the average or median, or a user-specified value associated with the correspondent. If there are any outstanding messages (no reply received) from a correspondent to the user to which the amount of time passed since the message was received is greater than the user's expected level of responsiveness for the correspondent (decision block 810), the user is alerted that some follow-up action may be desirable (block 812). A separate alert (e.g., mail message, task, or pop-up window) may be generated for each correspondent to whom the user may want to reply, or a single alert that identifies each such correspondent may be generated.

After checking for delayed replies by correspondents or the user, the process continues at block 814. In one embodiment, the process may wait for a selected period of time before determining new levels of responsiveness in order to reduce the computational load. In an alternative embodiment the process may immediately return to the processing of block 802.

Those skilled in the art will appreciate that various alternative computing arrangements would be suitable for hosting the processes of the different embodiments. In addition, the processes may be provided via a variety of computer-readable or other processor-readable media or delivery channels such as magnetic or optical disks or tapes, electronic storage devices, or as application services over a network.

The present invention is believed to be applicable to a variety of email programs. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A processor-implemented method for managing email messages for a user, comprising:
determining a responsiveness metric that describes a level of responsiveness as a function of a plurality of response time periods, each response time period being an amount of time elapsed between sending an email message and receiving a reply to the email message; and
displaying for the user information indicative of the responsiveness metric.

2. The method of claim 1, further comprising:
storing for each sent email message sent by the user, data that indicate a time at which the message was sent and identifiers of one or more correspondents to which the message was sent;
determining for each reply email message received as a response to a sent email message, a correspondent-response time period that is a period of time elapsed since the sent email message was sent and the time at which the reply email message was received;
determining a correspondent-responsiveness metric for each correspondent as a function of a plurality of correspondent-response time periods of reply messages from the correspondent to the user; and
displaying for the user information indicative of the correspondent-responsiveness metrics.

3. The method of claim 2, wherein the responsiveness metric is an average of the correspondent-response time periods, the method further comprising:
determining a percentage for each correspondent of a number of messages sent from the user to the correspondent to which the correspondent has sent one or more reply messages; and
displaying for the user the percentage in association with an identifier of each correspondent.

4. The method of claim 2, further comprising:
storing for each received email message received by the user, data that indicate a time at which the message was received and an identifier of a correspondent from which the message was received;
determining for each user-reply message sent by the user in response to a received message from a correspondent, a user-response time period that is a period of time elapsed between time of receipt of the received message and a time at which the user-reply message was sent;
determining a user-responsiveness metric for the user to each correspondent as a function of a plurality of user-response time periods of a plurality of reply messages from the user to the correspondent; and
displaying for the user information indicative of the user-responsiveness metrics.

5. The method of claim 4, further comprising providing an indication to the user for each correspondent for which the user-responsiveness metric exceeds the correspondent-responsiveness metric.

6. The method of claim 4, further comprising providing an indication to the user for each correspondent for which the correspondent-responsiveness metric exceeds the user-responsiveness metric.

7. The method of claim 1, further comprising:
storing for each received email message received by the user, data that indicate a time at which the message was received and an identifier of a correspondent from which the message was received;
determining for each user-reply message sent by the user in response to a received message from a correspondent, a user-response time period that is a period of time elapsed between receipt of the received message and a time at which the user-reply message was sent;
determining a user-responsiveness metric for the user to each correspondent as a function of a plurality of user-response time periods of a plurality of reply messages from the user to the correspondent; and
displaying for the user information indicative of the user-responsiveness metrics.

8. The method of claim 1, wherein the responsiveness metric is an average of the response time periods.

9. The method of claim 1, further comprising:
determining for each reply message received as a response to a sent message, a correspondent-response time period that is a period of time elapsed between sending of the sent email message and a time at which the reply email message was received;
determining a first expected response period for each correspondent as a function of a plurality of correspondent-response time periods of reply messages from the correspondent to the user; and
alerting the user to a message sent from the user to a correspondent to which the correspondent has not replied and for which time passed since the message was sent is greater than the first expected response period.

10. The method of claim 9, further comprising:
determining for each user-reply message sent by the user in response to a received message from a correspondent, a user-response time period that is a period of time elapsed between receipt of the received message and a time at which the user-reply message was sent;
determining a second expected response period for the user to each correspondent as a function of a plurality of user-response time periods of a plurality of reply messages from the user to the correspondent; and
alerting the user to a message received by the user from a correspondent to which the user has not replied and for which time passed since the message was received is greater than the second expected response period.

11. The method of claim 1, further comprising:
determining for each user-reply message sent by the user in response to a received message from a correspondent, a user-response time period that is a period of time elapsed between receipt of the received message and a time at which the user-reply message was sent;
determining a expected response period for the user to each correspondent as a function of a plurality of user-response time periods of a plurality of reply messages from the user to the correspondent; and
alerting the user to a message received by the user from a correspondent to which the user has not replied and for which time passed since the message was received is greater than the expected response period.

12. A processor-implemented method for managing email messages for a user, comprising:
determining a first set of responsiveness metrics, each responsiveness metric in the first set describing a level of responsiveness of one of a plurality of correspondents as a function of a plurality of correspondent-response time periods, each correspondent-response time period being an amount of time elapsed between sending an email message from the user to the correspondent and receiving a reply to the email message from the correspondent;
determining a second set of responsiveness metrics, each responsiveness metric in the second set describing a level of responsiveness of the user to one of a plurality of correspondents as a function of a plurality of user-response time periods, each user-response time period being an amount of time elapsed between receipt of an email message from a correspondent and sending of a reply to the email message from the user to the correspondent; and
displaying for the user information indicative of the first and second set of responsiveness metrics.

13. The method of claim 12, wherein the responsiveness metrics are averages of the correspondent-response time periods and user-response time periods.

14. The method of claim 13, further comprising:
determining a percentage for each correspondent of a number of messages sent from the user to the correspondent to which the correspondent has sent one or more reply messages; and
displaying for the user the percentage in association with an identifier of each correspondent.

15. The method of claim 12, further comprising providing an indication to the user for each correspondent for which the user-responsiveness metric indicates a greater level of responsiveness of the user than a level of responsiveness indicated by a correspondent-responsiveness metric associated with the correspondent.

16. The method of claim 15, further comprising providing an indication to the user for each correspondent for which the correspondent-responsiveness metric indicates a greater level of responsiveness of the correspondent than a level of responsiveness indicated by a user-responsiveness metric of the user to the correspondent.

17. The method of claim 12, further comprising:
determining a third set of responsiveness metrics, each responsiveness metric in the third set describing a level of responsiveness of one of a plurality of correspondents as a function of a plurality of response time periods, each measured by time elapsed between receipt of an email message by the correspondent and sending a reply to the email message by the correspondent; and
displaying for the user information indicative of the third set of responsiveness metrics.

18. The method of claim 12, wherein the first and second set of responsiveness metrics are accumulated by an email client.

19. The method of claim 12, wherein the first and second set of responsiveness metrics are accumulated by an email server.

20. An apparatus for managing email messages for a user, comprising:
means for determining a first set of responsiveness metrics, each responsiveness metric in the first set describing a level of responsiveness of one of a plurality of correspondents as a function of a plurality of correspondent-response time periods, each correspondent-response time period being an amount of time elapsed between sending an email message from the user to the correspondent and receiving a reply to the email message from the correspondent;
means for determining a second set of responsiveness metrics, each responsiveness metric in the second set describing a level of responsiveness of the user to one of a plurality of correspondents as a function of a plurality of user-response time periods, each user-response time period being an amount of time elapsed between receipt of an email message from a correspondent and sending of a reply to the email message from the user to the correspondent; and
means for displaying for the user information indicative of the first and second set of responsiveness metrics.

21. The apparatus of claim 20, further comprising means for providing an indication to the user for each correspondent for which the user-responsiveness metric indicates a greater level of responsiveness of the user than a level of responsiveness indicated by a correspondent-responsiveness metric associated with the correspondent.

22. The apparatus of claim 21, further comprising means for providing an indication to the user for each correspondent for which the correspondent-responsiveness metric indicates a greater level of responsiveness of the correspondent than a level of responsiveness indicated by a user-responsiveness metric of the user to the correspondent.

23. The apparatus of claim 20, further comprising:
means for determining a third set of responsiveness metrics, each responsiveness metric in the third set describing a level of responsiveness of one of a plurality of correspondents as a function of a plurality of response time periods, each measured by time elapsed between receipt of an email message by the correspondent and sending a reply to the email message by the correspondent; and
means for displaying for the user information indicative of the third set of responsiveness metrics.

24. An article of manufacture for managing email messages for a user, comprising:
a computer-readable medium configured with instructions for causing a processor-based system to perform the steps of,
determining a first set of responsiveness metrics, each responsiveness metric in the first set describing a level of responsiveness of one of a plurality of correspondents as a function of a plurality of correspondent-response time periods, each correspondent-response time period being an amount of time elapsed between sending an email message from the user to the correspondent and receiving a reply to the email message from the correspondent;
determining a second set of responsiveness metrics, each responsiveness metric in the second set describing a level of responsiveness of the user to one of a plurality of correspondents as a function of a plurality of user-response time periods, each user-response time period being an amount of time elapsed between receipt of an email message from a correspondent and sending of a reply to the email message from the user to the correspondent; and
displaying for the user information indicative of the first and second set of responsiveness metrics.

25. The article of manufacture claim 24, wherein the responsiveness metrics are averages of the correspondent-response time periods and user-response time periods.

26. The article of manufacture of claim 25, further configured with instructions for causing a processor-based system to perform the steps of:
determining a percentage for each correspondent of a number of messages sent from the user to the correspondent to which the correspondent has sent one or more reply messages; and
displaying for the user the percentage in association with an identifier of each correspondent.

27. The article of manufacture of claim 24, further configured with instructions for causing a processor-based system to perform the step providing an indication to the user for each correspondent for which the user-responsiveness metric indicates a greater level of responsiveness of the user than a level of responsiveness indicated by a correspondent-responsiveness metric associated with the correspondent.

28. The article of manufacture of claim 27, further configured with instructions for causing a processor-based system to perform the step of providing an indication to the user for each correspondent for which the correspondent-responsiveness metric indicates a greater level of responsiveness of the correspondent than a level of responsiveness indicated by a user-responsiveness metric of the user to the correspondent.

29. The article of manufacture of claim 24, further configured with instructions for causing a processor-based system to perform the steps of:
determining a third set of responsiveness metrics, each responsiveness metric in the third set describing a level of responsiveness of one of a plurality of correspondents as a function of a plurality of response time periods, each measured by time elapsed between receipt of an email message by the correspondent and sending a reply to the email message by the correspondent; and
displaying for the user information indicative of the third set of responsiveness metrics.
